(19) United States
(12) Patent Application Publication
(10) Pub. No.: US 2026/0054293 A1
(43) Pub. Date: Feb. 26, 2026

(54) SUBSTRATE PROCESSING METHOD AND SUBSTRATE PROCESSING APPARATUS

(71) Applicant: SEMES CO., LTD., Cheonan-si (KR)

(72) Inventors: Byung Woo SIM, Seoul (KR); Sun Mi KIM, Yeongam (KR); Won Jun HWANG, Hwaseong-si (KR); Jin Ah HAN, Cheonan-si (KR)

(73) Assignee: SEMES CO., LTD., Cheonan-si (KR)

(21) Appl. No.: 19/305,218

(22) Filed: Aug. 20, 2025

(30) Foreign Application Priority Data
Aug. 23, 2024 (KR) 10-2024-0113248

(51) Int. Cl. B08B 3/02; B08B 13/00

(52) U.S. Cl. CPC B08B 3/02; B08B 13/00

(57) ABSTRACT

Disclosed is a method of processing a substrate, the method including: a first liquid supplying operation of supplying a first liquid to a top surface of a substrate, in which the first liquid supplying operation includes: a first high-speed rotation operation of rotating the substrate at a first speed; and a first low-speed rotation operation of rotating the substrate at a second speed slower than the first speed, and in the first liquid supplying operation, the first liquid is supplied to a bottom surface of the substrate, and stopping the supply of the first liquid to the bottom surface of the substrate when the substrate is rotating at the second speed.

### CROSS-REFERENCE TO RELATED APPLICATION

This application claims priority to and the benefit of Korean Patent Application No. 10-2024-0113248 in the Korean Intellectual Property Office on Aug. 23, 2024, the entire contents of which are incorporated herein by reference.

### TECHNICAL FIELD

The present invention relates to a method and apparatus for processing a substrate, and more specifically, to a substrate processing method and a substrate processing apparatus for liquid treating a substrate by supplying a liquid to the substrate.

### BACKGROUND ART

In general, various processes, such as photo process, etching process, ion implantation process, and deposition process, are performed to manufacture semiconductor devices.

In the process of performing each process, various foreign substances, such as particles, organic contaminants, and metal impurities, are generated. The generated foreign substances cause defects in the substrate and act as a factor that directly affects the performance and yield of the semiconductor device. Accordingly, before and after the semiconductor device manufacturing processes are performed, a cleaning process for removing foreign substances remaining on the substrate is performed.

The cleaning process includes removing foreign substances remaining on the substrate using chemical, removing the chemical liquid remaining on the substrate using a cleaning liquid, such as pure water (Deionized Water (DIW)), removing the cleaning liquid remaining on the substrate using an organic solvent having bottom surface tension than the cleaning liquid, and drying the organic solvent remaining on the surface of the substrate. The cleaning process includes a process of supplying chemical to a rotating substrate supported by a spin head, a process of removing the chemical from the substrate by supplying a cleaning liquid, such as pure water (DIW), to the substrate, a process of replacing the cleaning liquid on the substrate with an organic solvent by supplying an organic solvent, such as isopropyl alcohol (IPA), with bottom surface tension than the cleaning liquid, and a process of removing the replaced organic solvent from the substrate.

Various liquids are used in the process of performing the cleaning process. For example, when the substrate W is sequentially treated with a first liquid L1 to a second liquid L2, a supply gap of the treatment liquid may occur instantly until the second liquid L2 is supplied after the first liquid L1 is supplied. Accordingly, when the second liquid L2 is supplied to the substrate W, the supplied second liquid L2 may hit the substrate W to be rebound, and the rebound liquid may cause particles and contaminate the substrate W.

In addition, as a supply gap of the treatment liquid occurs instantaneously on the substrate W, the second liquid L2 is not smoothly applied on the substrate W, and thus a finger ring phenomenon may occur. This may cause a treatment failure of the substrate W.

### SUMMARY OF THE INVENTION

The present invention has been made in an effort to provide a substrate processing method and a substrate processing apparatus capable of efficiently cleaning a substrate.

The present invention has also been made in an effort to provide a substrate processing method and a substrate processing apparatus capable of minimizing contamination of a substrate.

The present invention has also been made in an effort to provide a substrate processing method and a substrate processing apparatus capable of preventing a liquid supplied to a substrate from being rebounded.

The present invention has also been made in an effort to provide a substrate processing method and a substrate processing apparatus capable of preventing the occurrence of a finger ring phenomenon on a substrate.

The objectives of the present disclosure are not limited thereto and other objectives not stated herein may be clearly understood by those skilled in the art from the following description.

An exemplary embodiment of the present invention, a method of processing a substrate, the method comprising: a first liquid supplying operation of supplying a first liquid to a top surface of a substrate, wherein the first liquid supplying operation includes: a first high-speed rotation operation of rotating the substrate at a first speed; and a first low-speed rotation operation of rotating the substrate at a second speed slower than the first speed, and in the first liquid supplying operation, the first liquid is supplied to a bottom surface of the substrate, and stopping the supply of the first liquid to the bottom surface of the substrate when the substrate is rotating at the second speed.

According to the exemplary embodiment of the present invention, wherein in the first high-speed rotation operation, the first liquid may be supplied to the substrate while gradually decreasing the rotation speed of the substrate from the first speed to the second speed slower than the first speed.

According to the exemplary embodiment of the present invention, the method may further include after the first liquid supplying operation, a liquid film forming operation of stopping the supply of the first liquid and forming a liquid film of the first liquid on the top surface of the substrate; and after the liquid film forming operation, a second liquid supplying operation in which the liquid film of the first liquid is replaced with the second liquid by supplying the second liquid to the substrate.

According to the exemplary embodiment of the present invention, wherein the first liquid supplying operation is performed for a first time, the liquid film forming operation is performed for a second time, and the first time may be longer than the second time.

According to the exemplary embodiment of the present invention, wherein in the liquid film forming operation, the substrate may rotates at the second speed.

According to the exemplary embodiment of the present invention, wherein in the liquid film forming operation, the substrate may stops rotating.

According to the exemplary embodiment of the present invention, wherein the second liquid supplying operation may includes a second low-speed rotation operation of supplying the second liquid to a center area of the top surface of the substrate while rotating the substrate at the second speed to replace the liquid film of the first liquid formed in the center area of the top surface of the substrate with the second liquid.

According to the exemplary embodiment of the present invention, wherein the second liquid supplying operation may includes a second high-speed rotation operation of replacing the liquid film of the first liquid formed on the substrate with the second liquid while incrementally increasing the rotation speed of the substrate from the second speed to a third speed faster than the second speed after the second low-speed rotation operation.

According to the exemplary embodiment of the present invention, wherein the third speed may be faster than the first speed.

According to the exemplary embodiment of the present invention, wherein in the second high-speed rotation operation, the second liquid may be supplied to the center area of the substrate.

According to the exemplary embodiment of the present invention, wherein in the second high-speed rotation operation, the second liquid may be supplied while moving from the center area of the substrate to an edge area of the substrate.

According to the exemplary embodiment of the present invention, the method may further include after the second liquid supplying operation, a drying operation of drying the substrate by volatilizing the second liquid on the substrate.

According to the exemplary embodiment of the present invention, wherein the first liquid may includes pure water, and the second liquid contains isopropyl alcohol (IPA).

An exemplary embodiment of the present invention, an apparatus for processing a substrate, the apparatus comprising: a liquid treating chamber for supplying a liquid to a substrate to liquid-treat the substrate; and a controller for controlling the liquid treating chamber, wherein the liquid treating chamber includes: a housing having an inner space; a support unit for supporting and rotating the substrate within the inner space; and a liquid supply unit for supplying a liquid to the substrate placed on the support unit, and the liquid supply unit further includes: a first liquid supply nozzle for supplying a first liquid to a top surface of the substrate; a second liquid supply nozzle for supplying a second liquid to the top surface of the substrate; and a back nozzle for supplying the first liquid to a bottom surface of the substrate, and the controller supplies the first liquid to the top surface and the bottom surface of the substrate while rotating the substrate at a first speed, supplies the first liquid to the top surface of the substrate while rotating the substrate at a second speed, stops supplying the first liquid, and then may rotates the substrate at a second speed so as to form a liquid film of the first liquid on the top surface of the substrate.

According to the exemplary embodiment of the present invention, wherein the controller may moves the second liquid supply nozzle to the center area of the top surface of the substrate while the supply of the first liquid is stopped and the substrate rotates at the second speed.

According to the exemplary embodiment of the present invention, wherein the controller moves the second liquid supply nozzle to the center area of the top surface of the substrate and then may controls supply of the second liquid to the center area of the top surface of the substrate through the second liquid supply nozzle while rotating the substrate at the second speed.

According to the exemplary embodiment of the present invention, wherein the controller may controls the second liquid to be supplied to the substrate through the second liquid supply nozzle while incrementally increasing a rotation speed of the substrate from the second speed to a third speed faster than the second speed.

An exemplary embodiment of the present invention, a method of processing a substrate, the method comprising: a first liquid supplying operation of supplying pure water to a top surface of a substrate; after the first liquid supplying operation, a liquid film forming operation of stopping the supply of the pure water and forming a liquid film of the pure water on the top surface of the substrate; after the liquid film forming operation, a second liquid supplying operation in which an organic solvent is supplied to the substrate to replace the pure water of the first liquid with the organic solvent; and a drying operation of drying the substrate by volatilizing the organic solvent on the substrate, wherein the first liquid supplying operation includes: a first high-speed rotation operation of rotating the substrate at a first speed; and a first low-speed rotation operation of rotating the substrate at a second speed slower than the first speed, and in the first liquid supplying operation, the pure water is supplied to a bottom surface of the substrate, and when the substrate rotates at the second speed, the supply of the pure water to the bottom surface of the substrate is stopped, and the second liquid supplying operation further may includes, a second low-speed rotation operation of supplying the organic solvent to a center area of the top surface of the substrate while rotating the substrate at the second speed to replace the liquid film of the pure water formed in the center area of the top surface of the substrate with the organic solvent, and a second high-speed rotation operation that replaces the liquid film of the pure water formed on the substrate with the organic solvent by supplying the organic solvent to the center area of the substrate while incrementally increasing the rotation speed of the substrate from the second speed to a third speed faster than the second speed, after the second low-speed rotation operation.

According to the exemplary embodiment of the present invention, wherein in the liquid film forming operation, the substrate may rotates at the second speed.

According to the exemplary embodiment of the present invention, wherein the third speed may be faster than the first speed.

According to the exemplary embodiment of the present invention, it is possible to efficiently clean a substrate.

According to the exemplary embodiment of the present invention, it is possible to minimize contamination of the substrate.

In addition, according to the exemplary embodiment of the present invention, it is possible to prevent the liquid supplied to the substrate from being rebounded.

In addition, according to the exemplary embodiment of the present invention, it is possible to prevent the occurrence of a finger ring phenomenon on the substrate.

Effects of the present disclosure are not limited to those described above and effects not stated above will be clearly understood to those skilled in the art from the specification and the accompanying drawings.

### BRIEF DESCRIPTION OF THE DRAWINGS

Various features and advantages of the non-limiting exemplary embodiments of the present specification may become apparent upon review of the detailed description in conjunction with the accompanying drawings. The attached drawings are provided for illustrative purposes only and should not be construed to limit the scope of the claims. The accompanying drawings are not considered to be drawn to scale unless explicitly stated. Various dimensions in the drawing may be exaggerated for clarity.

FIG. 1 is a diagram schematically illustrating a substrate processing apparatus according to an exemplary embodiment of the present invention.

FIG. 2 is a diagram schematically illustrating a liquid treating chamber of FIG. 1 according to an exemplary embodiment.

FIG. 3 is a flowchart of a substrate processing method according to an exemplary embodiment of the present invention.

FIG. 4 is a diagram illustrating an exemplary embodiment of a rotation speed of a substrate and liquid supply over time in each operation of FIG. 3.

FIG. 5 is a diagram schematically illustrating a state of processing a substrate in a first high-speed rotation operation of FIG. 3 according to the exemplary embodiment.

FIG. 6 is a diagram schematically illustrating a state of processing a substrate in a first low-speed rotation operation of FIG. 3 according to the exemplary embodiment.

FIG. 7 is a diagram schematically illustrating a state of processing a substrate in a liquid film forming operation of FIG. 3, according to the exemplary embodiment.

FIG. 8 is a diagram schematically illustrating a state of processing a substrate in a second low-speed rotation operation of FIG. 3 according to the exemplary embodiment.

FIG. 9 is a diagram schematically illustrating a state of processing a substrate in a second high-speed rotation operation of FIG. 3 according to the exemplary embodiment.

FIG. 10 is a diagram schematically illustrating a state of processing a substrate in a drying operation of FIG. 3 according to the exemplary embodiment.

FIGS. 11 to 13 are diagrams illustrating a rotation speed of a substrate and liquid supply according to each operation of FIG. 3 according to other exemplary embodiments.

FIG. 14 is a diagram schematically illustrating a state of processing a substrate in a second high-speed rotation operation of FIG. 3 according to another exemplary embodiment.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In the present exemplary embodiment, a process of liquid-treating the substrate W by supplying a liquid, such as a cleaning liquid, onto a substrate W is described as an example. However, the present exemplary embodiment is not limited to the cleaning process, and may be applied to various processes of treating the substrate W using a liquid, such as an etching process, an ashing process, or a developing process.

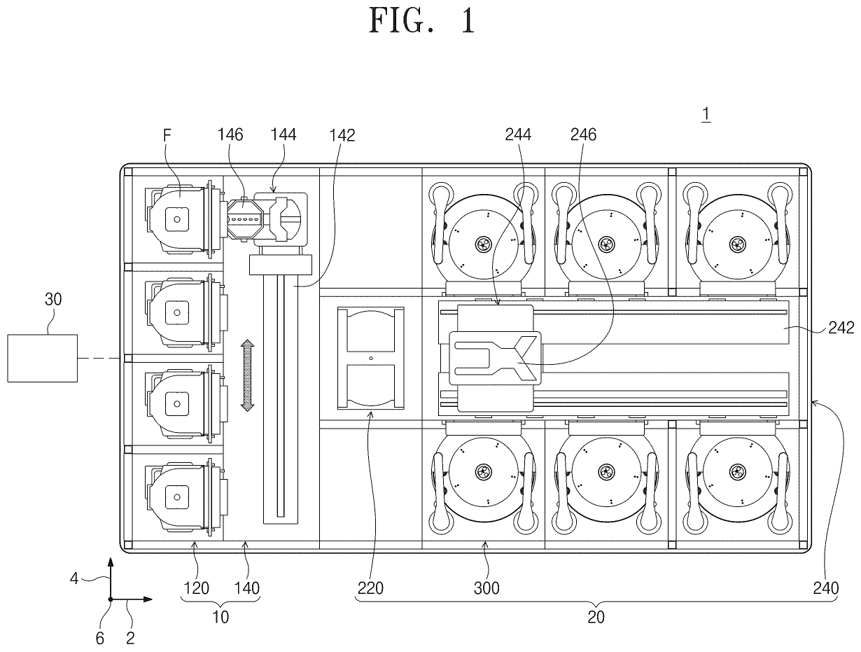

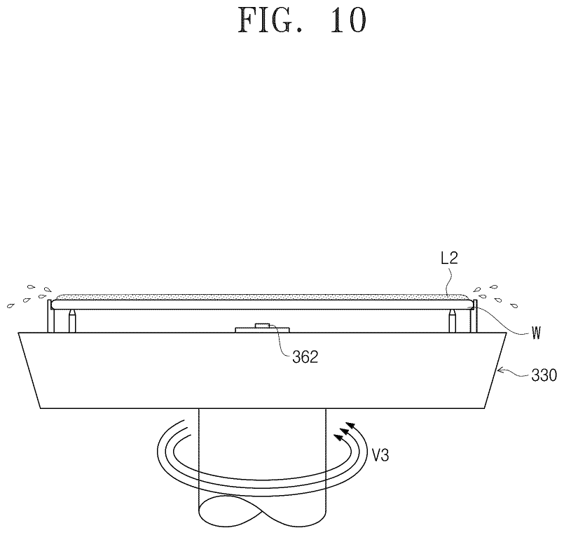

Hereinafter, an exemplary embodiment of the present invention will be described with reference to FIGS. 1 to 14. A substrate processing apparatus 1 according to an exemplary embodiment of the present invention may perform a cleaning process including a drying process of drying a substrate W using a process fluid.

FIG. 1 is a top plan view schematically illustrating a substrate processing apparatus according to an exemplary embodiment of the present invention. Referring to FIG. 1, a substrate processing apparatus 1 includes an index module 10 and a treating module 20. According to an example, the index module 10 and the treating module 20 are disposed along one direction. Hereinafter, a direction in which the index module 10 and the treating module 20 are arranged is defined as a first direction 2. When viewed from above, a direction perpendicular to the first direction 2 is defined as a second direction 4, and a direction perpendicular to the plane including both the first direction 2 and the second direction 4 is defined as a third direction 6.

The index module 10 transfers a substrate W from a container F in which the substrate W is accommodated to the treating module 20 treating the substrate W. The index module 10 accommodates the substrate W completely processed in the treating module 20 into the container F. A longitudinal direction of the index module 10 is provided in the second direction 4. The index module 10 includes a load port 120 and an index frame 140.

The container F in which the substrate W is accommodated is seated on the load port 120. Based on the index frame 130, the load port 120 is located at a side opposite to the treating module 20. A plurality of load ports 120 may be provided. A plurality of load ports 120 may be arranged in a line along the second direction 4. The number of load ports 120 may increase or decrease according to the process efficiency and footprint conditions of the treating module 20.

A plurality of slots (not illustrated) is formed in the container F. The slots (not illustrated) may accommodate the substrates W in a state in which the substrates W are disposed horizontally with respect to the ground. As the container F, an airtight container, such as a Front Open Unified Pod (FOUP), may be used. The container F may be placed on the load port 120 by a transfer means (not illustrated), such as an overhead transfer, an overhead conveyor, or an automatic guided vehicle, or an operator.

An index rail 142 and an index robot 144 are provided in the index frame 140. The index rail 142 is provided in the index frame 140 along the second direction 4 in its longitudinal direction. The index robot 144 may transfer the substrate W. The index robot 144 may transfer the substrate W between the index module 10 and a buffer unit 220 to be described later.

The index robot 144 includes an index hand 146. The substrate W is mounted on the index hand 146. The index hand 146 may be provided on the index rail 142 to be movable along the second direction 4. Accordingly, the index hand 146 may be moved forward and backward along the index rail 142. Also, the index hand 146 may be provided to be rotatable with respect to the third direction 6. Also, the index hand 146 may be provided to be vertically movable along the third direction 6. A plurality of index hands 146 may be provided. A plurality of index hands 146 may be provided to be spaced apart from each other in the vertical direction. A plurality of index hands 146 may move forward, backward, and rotate independently of each other.

The controller 30 controls the substrate processing apparatus 1. The controller 30 may include a process controller formed of a microprocessor (computer) that executes the control of the substrate treating apparatus 1, a user interface formed of a keyboard in which an operator performs a command input operation or the like in order to manage the substrate treating apparatus 1, a display for visualizing and displaying an operation situation of the substrate treating apparatus 1, and the like, and a storage unit storing a control program for executing the process executed in the substrate treating apparatus 1 under the control of the process controller or a program, that is, a treating recipe, for executing the process in each component according to various data and treating conditions. Further, the user interface and the storage unit may be connected to the process controller. The processing recipe may be stored in a storage medium in the storage unit, and the storage medium may be a hard disk, and may also be a portable disk, such as a CD-ROM or a DVD, or a semiconductor memory, such as a flash memory.

The controller 30 may control the substrate processing apparatus 1 to perform the substrate processing method described below. For example, the controller 30 may control the components provided to the liquid treating chamber 300 so as to perform a substrate processing method described below.

The treating module 20 includes a buffer unit 220, a transfer chamber 300, and a liquid treating chamber 400. The buffer unit 220 provides a space in which the substrate W loaded into the treating module 20 and the substrate W unloaded from the treating module 20 stay temporarily. The transfer frame 240 provides a transfer space for transferring the substrate W between the buffer unit 220 and the liquid treating chamber 300.

The liquid treating chamber 300 performs a liquid treating process of liquid treating the substrate W by supplying a liquid onto the substrate W. The liquid treating chamber 300 may perform a cleaning process. The cleaning process may be performed in the liquid treating chamber 300. For example, the liquid treating chamber 300 may treat the substrate W by supplying a chemical, a rinse liquid, and/or an organic solvent onto the substrate W. The treatment of the substrate W performed in the liquid treating chamber 300 may include a spin drying treatment for removing the liquid remaining on the substrate W by rotating the substrate W. The buffer unit 220 may be disposed between the index frame 140 and the transfer frame 240. The buffer unit 220 may be located at one end of the transfer frame 240. A slot (not illustrated) in which the substrate W is placed is provided in the buffer unit 220. A plurality of slots (not illustrated) is provided. A plurality of slots (not illustrated) is provided to be spaced apart from each other along a third direction 6. A front face and a rear face of the buffer unit 220 are opened. The front face is a face facing the index module 10, and the rear face is a face facing the transfer frame 240. The index robot 144 may approach the buffer unit 220 through the front face, and the transfer robot 244 may approach the buffer unit 220 through the rear face.

The transfer frame 240 may be provided so that a longitudinal direction is the first direction 2. The liquid treating chambers 300 may be disposed on opposite sides of the transfer frame 240. The liquid treating chamber 400 may be disposed on a side portion of the transfer frame 300. The transfer frame 240 and the liquid treating chamber 300 may be disposed along the second direction 4.

According to the example, the liquid treating chambers 300 are respectively disposed on opposite sides of the transfer frame 240. At one side of the transfer frame 240, the liquid treating chambers 300 may be provided in an array of A×B (each of A and B is 1 or a natural number larger than 1) in the first direction 2 and the third direction 6. Here, A is the number of liquid treating chambers 300 provided in a row along the first direction 2, and B is the number of liquid treating chambers 300 provided in a row along the third direction 6. For example, when six liquid treating chambers 300 are provided at one side of the transfer frame 240, the liquid treating chambers 300 may be arranged in a 3×2 array. The number of liquid treating chambers 300 may increase or decrease. Unlike the above description, the liquid treating chamber 300 may be provided as a single layer on one side and opposite sides of the conveyance frame 240.

The transfer frame 240 includes a guide rail 242 and a transfer robot 244. The guide rail 242 is provided within the transfer frame 240 in the first direction 2 in a longitudinal direction thereof. The transfer robot 244 may be provided on the guide rail 242 to be able to move linearly along the first direction 2. The transfer robot 244 transfers the substrate W between the buffer unit 220 and the liquid treating chamber 300.

The transfer robot 244 includes a transfer hand 246 on which the substrate W is placed. The transfer hand 246 may be provided on the guide rail 242 to be movable along the first direction 2. Accordingly, the transfer hand 246 may be moved forward and backward along the guide rail 242. Also, the transfer hand 246 may be provided to be rotated around the third direction 6 and be movable along the third direction 6. A plurality of transfer hands 246 may be provided. A plurality of transfer hands 246 may be provided to be spaced apart from each other in the vertical direction. A plurality of transfer hands 246 may move forward, backward, and rotate independently of each other.

The liquid treating chamber 300 performs a liquid treatment process on the substrate W. For example, the liquid treating chamber 300 may be a chamber that performs a cleaning process for removing process by-products or the like attached to the substrate W. The liquid treating chamber 300 may have different structures depending on the type of process for treating the substrate W. Alternatively, each of the liquid treating chambers 300 may have the same structure.

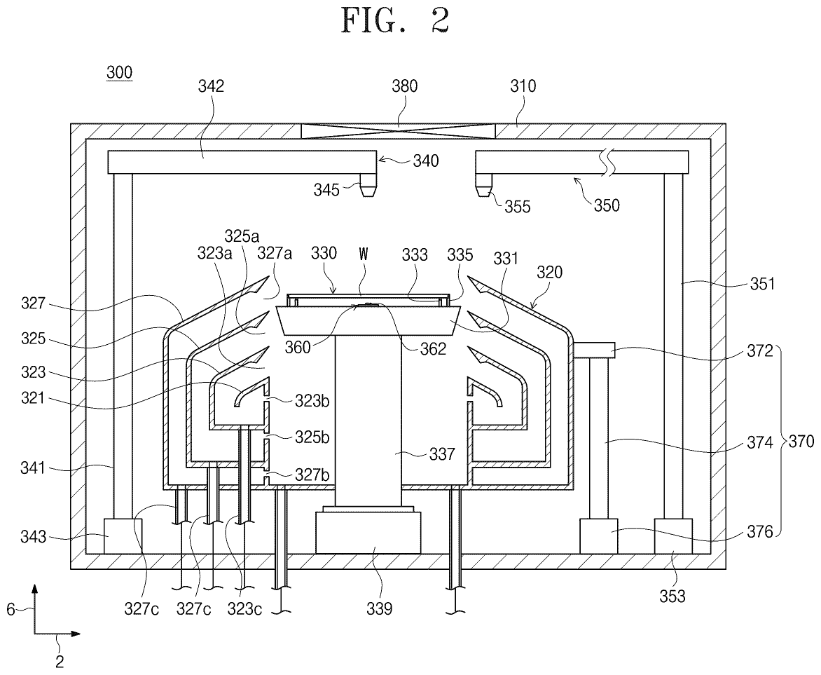

FIG. 2 is a diagram schematically illustrating the liquid treating chamber of FIG. 1 according to an exemplary embodiment. Referring to FIG. 2, the liquid treating chamber 300 includes a housing 310, a treatment container 320, a support unit 330, and liquid supply units 340, 350 and 360.

The housing 310 has an inner space. The housing 310 is provided in a generally rectangular parallelepiped shape. An opening (not illustrated) is formed at one side of the housing 310. The opening (not illustrated) functions as an entrance through which the substrate W is loaded in or unloaded from the inner space of the housing 310 by the transfer robot 244. The treatment container 320, the support unit 330, and the liquid supply units 340, 350 and 360 are disposed in the inner space of the housing 310.

The treatment container 320 has a treatment space with an open top. The treatment container 320 may be a bowl having a treatment space. The treatment container 320 may be provided to surround the treatment space. The treatment space of the treatment container 320 is provided as a space in which the support unit 330 described later supports and rotates the substrate W. The treatment space is provided as a space in which the liquid supply units 340, 350, and 360 described later supply a liquid onto the substrate W to treat the substrate W.

According to an example, the treatment container 320 may include a guide wall 321 and a plurality of recovery containers 323, 325, and 327. Each of the recovery containers 323, 325, and 327 separates and recovers a different liquid from among liquids used for the treatment of the substrate W. Each of the recovery containers 323, 325, and 327 has a recovery space of recovering the liquid used for the processing of the substrate.

The guide wall 321 and the recovery containers 323, 325, and 327 are provided in an annular ring shape surrounding the support unit 330. When a liquid is supplied onto the substrate W, a liquid scattered by rotation of the substrate W may be introduced into the recovery space through inlets 323a, 325a, and 327a to be described below of the recovery containers 323, 325, and 327. Different types of liquid may be introduced into each of the recovery containers 323, 325, and 327.

The treatment container 320 has a guide wall 321, a first recovery container 323, a second recovery container 325, and a third recovery container 327. The guide wall 321 is provided in a ring shape surrounding the support unit 330. The first recovery container 323 is provided in a ring shape surrounding the guide wall 321. The second recovery container 325 is provided in a ring shape surrounding the first recovery container 323. The third recovery container 327 is provided in a ring shape surrounding the second recovery container 325.

A space between the guide wall 321 and the first recovery container 323 functions as a first inlet 323a through which a liquid is introduced. A space between the first recovery container 323 and the second recovery container 325 functions as a second inlet 325a through which a liquid is introduced. A space between the second recovery container 325 and the third recovery container 327 functions as a third inlet 327a through which a liquid is introduced. The second inlet 325a may be located above the first inlet 323a, and the third inlet 327a may be located above the second inlet 325a. The liquid introduced into the first inlet 323a, the liquid introduced into the second inlet 325a, and the liquid introduced into the third inlet 327a may be different types of liquids.

A space between a lower end of the guide wall 321 and the first recovery container 323 functions as a first outlet 323b through which fumes generated from the liquid and airflow are discharged. A space between a lower end of the first recovery container 323 and the second recovery container 325 functions as a second outlet 325b through which fumes generated from the liquid and airflow are discharged. A space between a lower end of the second recovery container 325 and the third recovery container 327 functions as a third outlet 327b through which fumes generated from the liquid and airflow are discharged. Fumes and airflow discharged from the first outlet 323b, the second outlet 325b, and the third outlet 327b are exhausted to the outside of the liquid treating chamber 300 through an exhaust unit to be described later.

Recovery lines 323c, 325c, and 327c extending vertically in a downward direction are connected to bottom surfaces of the recovery vessels 323, 325, and 327, respectively. Each of the recovery lines 323c, 325c, and 327c discharges a liquid introduced through each of the recovery vessels 323, 325, and 327. The discharged treatment liquid may be reused by an external liquid regeneration system (not illustrated).

The support unit 330 supports and rotates the substrate W in the treatment space. The support unit 330 may include a spin chuck 331, a support pin 333, a chuck pin 335, a rotating shaft 337, and a driver 339.

The spin chuck 331 has a top surface that is provided in a generally circular shape when viewed from above. The top surface of the spin chuck 331 may have a larger diameter than the substrate W.

A plurality of support pins 333 is provided. The supporting pin 333 is disposed on the top surface of the spin chuck 331. The support pin 333 is disposed on the edge of the top surface of the spin chuck 331 to be spaced apart from each other at a predetermined interval. The support pin 333 is formed to protrude upward from the top surface of the spin chuck 331. The support pins 333 are disposed to have an annular ring shape as a whole by a combination thereof. The support pin 333 supports the rear edge area of the substrate W so that the substrate W is spaced apart from the top surface of the spin chuck 331 by a predetermined distance.

A plurality of chuck pins 335 is provided. The chuck pin 335 is disposed to be relatively farther from the center area of the spin chuck 331 than the support pin 333. The chuck pin 335 protrudes upward from the top surface of the spin chuck 331. The chuck pin 335 supports a side area of the substrate W so as not to be separated from the correct position in the lateral direction when the substrate W is rotated. The chuck pin 335 is provided to be able to move linearly between a standby position and a support position along a radial direction of the spin chuck 331. The standby position is defined as the position of the chuck pin 335 when receiving the substrate W from the transfer robot 244 or handing over the substrate W to the transfer robot 244. The support position is defined as the position of the chuck pin 336 when performing a process on the substrate W. In the support position, the chuck pin 335 is in contact with the side portion of the substrate W. The standby position is provided to a position relatively far from the center of the spin chuck 331 compared to the support position.

The rotation shaft 337 is coupled to the spin chuck 331. The rotation shaft 337 is coupled to a bottom surface of the spin chuck 331. The rotation shaft 337 may be provided such that a longitudinal direction thereof faces the third direction 6. The rotation shaft 337 is provided to be rotatable by receiving power from the driver 339. The rotation shaft 337 is rotated by the driver 339, and the spin chuck 331 is rotated by the rotation shaft 337. The driver 339 rotates the rotation shaft 337. The driver 339 may vary the rotation speed of the rotation shaft 337. The driver 339 may be a motor that provides driving force. However, the present invention is not limited thereto, and may be variously modified and provided as a known device that provides driving force.

The liquid supply units 340, 350 and 360 supply the treatment liquid to the substrate W. The liquid supply units 340, 350 and 360 supply the treatment liquid to the substrate W supported by the support unit 330. The treatment liquid supplied by the liquid supply units 340, 350 and 360 to the substrate W is provided in a plurality of types. According to an example, the treatment liquid supplied by the liquid supply unit 340 to the substrate W may include a first liquid and a second liquid. The first liquid and the second liquid may be sequentially supplied to the substrate W.

According to an example, the liquid supply units 340, 350, and 360 may include a first liquid supply unit 340, a second liquid supply unit 350, and a back nozzle unit 360.

The first liquid supply unit 340 may include a support rod 341, an arm 342, a driver 343, and a first liquid supply nozzle 345.

The support rod 341 is located in the inner space of the housing 310. The support rod 341 is located on one side of the treatment container 320 in the inner space. The support rod 341 may have a rod shape whose longitudinal direction faces the third direction 6. The support rod 341 is provided to be rotatable by the driver 343 to be described later.

The arm 342 is coupled to an upper end of the support rod 341. The arm 342 extends vertically from the longitudinal direction of the support rod 341. A longitudinal direction of the arm 342 may be formed in the third direction 6. The first liquid supply nozzle 345 to be described later may be fixedly coupled to an end of the arm 342.

The arm 342 may be provided to be able to move forward and backward along the longitudinal direction thereof. The arm 342 may be swing-moved by the driver 343 that rotates the support rod 341 via the support rod 341. According to an example, when viewed from above, a path through which the other end of the arm 342 moves may be provided to pass through a center of the substrate W. By rotation of the arm 342, the first liquid supply nozzle 345 may also be swing-moved and moved between the process position and the standby position.

The process position may be a position where the first liquid supply nozzle 345 is opposite to the substrate W supported by the support unit 330. According to an example, the process position may be a position where the center of the first liquid supply nozzle 344 and the center of the substrate W supported by the support unit 330 face each other. The standby position may be a position where the first liquid supply nozzle 344 is out of the process position.

The driver 343 is coupled with the support rod 341. The driver 343 may be disposed on the bottom surface of the housing 310. The driver 343 provides driving force for rotating the support rod 341. The driver 343 may be provided as a known motor for providing driving force.

The first liquid supply nozzle 345 supplies the first liquid onto the substrate W. The first liquid supply nozzle 345 may supply the first liquid onto the substrate W supported by the support unit 330.

The first liquid may be a cleaning liquid for cleaning the substrate W. According to an example, the first liquid may include water. The first liquid may be pure water (DIW).

The second liquid supply unit 350 may include a support rod 351, an arm 352, a driver 353, and a second liquid supply nozzle 355.

Since the second liquid supply unit 350 has the same shape as the first liquid supply unit 340, a detailed description thereof will be omitted.

The second liquid may be a volatile organic solvent, pure water, or a mixture of a surfactant and pure water. The second liquid may be isopropyl alcohol (IPA).

The back nozzle unit 360 supplies a treatment liquid to the bottom surface of the substrate W. The back nozzle unit 360 includes a back nozzle 362, and is located below the substrate W supported by the support unit 330. When viewed from above, the back nozzle 362 is located at the center of the top surface of the support plate. The bag nozzle 362 is provided such that the discharge port thereof faces upward. For example, the treatment liquid discharged from the back nozzle unit 360 may be the same type of treatment liquid as the treatment liquid used in the first liquid supply unit 340. For example, the back nozzle unit 360 may supply the first liquid to the bottom surface of the substrate W.

Although the present invention has been described based on the case where the liquid supply units 340, 350 and 360 according to the exemplary embodiment of the present invention described above have the first liquid supply unit 340 and the second liquid supply unit 350 for supplying the treatment liquid to the top surface of the substrate, and the treatment liquid includes the first liquid and the second liquid, the present invention is not limited thereto. For example, the treatment liquid may further include a chemical having an acid or a basic property. The chemical may be a liquid that generates fumes. The chemical may be a liquid that removes a film or foreign matter remaining on the substrate W. The chemical may include phosphoric acid (H₃PO₄) or sulfuric acid (H₂SO₄). The liquid supply unit may further include a separate supply unit for supplying a chemical onto the substrate W in addition to the first liquid supply unit 340, the second liquid supply unit 350, and the back nozzle unit 360.

The lifting unit 370 is disposed in the inner space of the housing 310. The lifting unit 370 adjusts the relative height between the treatment container 320 and the supporting unit 330. The lifting unit 370 may linearly move the treatment container 320 in the third direction 6. Accordingly, since the heights of the recovery containers 323, 325, and 327 for recovering the liquid are changed according to the type of liquid supplied to the substrate W, the liquid may be separated and recovered. Unlike the above description, the treatment container 320 is fixedly installed, and the lifting unit 370 may change the relative height between the support unit 330 and the treatment container 320 by moving the supporting unit 330 in the vertical direction.

The airflow supply unit 380 supplies airflow to the inner space of the housing 310. The airflow supply unit 380 may supply descending airflow to the inner space. The airflow supply unit 380 may be provided as a fan filter unit. The airflow supply unit 360 may be installed on an upper portion of the housing 310. Gas supplied to the inner space of the housing 310 through the airflow supply unit 380 forms descending airflow in the inner space. By-products or the like generated in the treatment space during the process are discharged to the outside of the housing 310 through an exhaust unit (not illustrated) by descending airflow formed in the inner space and the treatment space.

The exhaust unit (not illustrated) exhausts process by-products, such as fumes and gas, generated in the treatment space. Process by-products, such as fumes and gas, generated when the substrate W is liquid-treated are exhausted by a pressure reducing unit (not illustrated) provided in the exhaust unit (not illustrated). The exhaust unit (not illustrated) may be coupled to the bottom surface of the treatment container 320. For example, the exhaust unit (not illustrated) may be disposed in the space between the rotation shaft 337 and the inner wall of the treatment container 320.

Hereinafter, a substrate processing method according to an exemplary embodiment of the present invention will be described in detail. The substrate treatment method described below may be performed by the substrate treatment apparatus 1 including the transfer robot 244 and the liquid treating chamber 300. Further, the controller 30 may perform the substrate treatment method described below by controlling components of the substrate treatment apparatus 1, such as the transfer robot 244 and the liquid treating chamber 300.

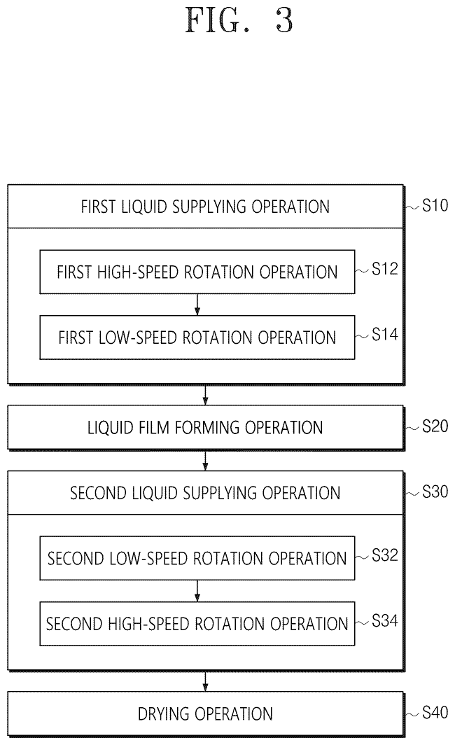

FIG. 3 is a flowchart of a substrate processing method according to an exemplary embodiment of the present invention. Referring to FIG. 3, a substrate processing method according to an exemplary embodiment includes a first liquid supplying operation S10, a liquid film forming operation S20, a second liquid supplying operation S30, and a drying operation S40. The first liquid supplying operation S10 includes a first high-speed rotation operation S12 and a first low-speed rotation operation S14, and the second liquid supplying operation S30 includes a second low-speed rotation operation S32 and a second high-speed rotation operation S34.

The first liquid supplying operation S10, the liquid film forming operation S20, the second liquid supplying operation S30, and the drying operation S40 may be sequentially performed. In addition, the first liquid supplying operation S10, the liquid film forming operation S20, and the second liquid supplying operation S30 may be collectively defined as a cleaning process, and the drying operation S40 may be defined as a drying process.

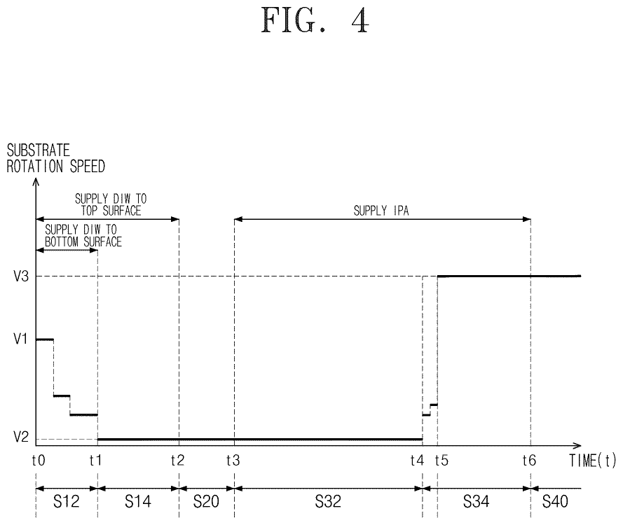

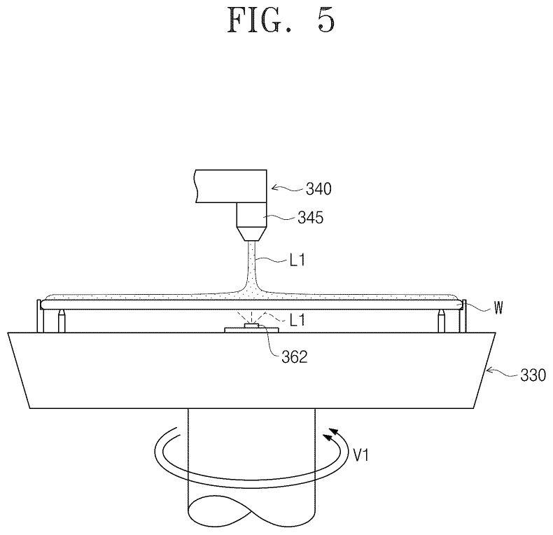

FIG. 4 is a diagram illustrating an exemplary embodiment of a rotation speed of a substrate and liquid supply over time in each operation of FIG. 3, and FIGS. 5 to 10 are diagrams schematically illustrating a state of processing a substrate in each operation of FIG. 3. Hereinafter, the substrate processing method of FIG. 3 according to the exemplary embodiment will be described with reference to FIGS. 4 to 10.

In FIG. 4, for convenience of explanation, the first liquid L1 supplied to the top and bottom surfaces of the substrate W is illustrated as pure water (DIW), and the second liquid L2 supplied to the top surface of the substrate W is illustrated as isopropyl alcohol (IPA). However, the first liquid and the second liquid are not limited thereto, and various treatment liquids may be used.

The rotation speed of the substrate W described in FIG. 4 and below is described based on a relative numerical relationship for convenience of description, but it should be noted that the absolute rotation speed value (rpm) expressed as an example is only an example and the present invention is not limited thereto. In addition, the time for rotating at each rotation speed illustrated in FIG. 4 is also an example illustrated for convenience of description, and it should be noted that the length (time) of the x-axis component of each operation illustrated in FIG. 4 does not indicate the process time of each operation or is proportional to the process time of each operation.

The first liquid supplying operation S10 is an operation of treating the substrate W by supplying the first liquid L1 to the substrate W. In the first liquid supplying operation S10, the first liquid L1 is supplied to the substrate W. The first liquid may be pure water (DIW).

The first liquid supplying operation S10 includes the first high-speed rotation operation S12 of gradually reducing the rotation speed of the substrate W from about a few hundred rpm while supplying the first liquid L1 to the top and bottom surfaces of the substrate W, and the first low-speed rotation operation S14 of stopping the supply of the first liquid L1 to the bottom surface of the substrate W at a few to several tens of rpm and supplying the first liquid L1 only to the top surface of the substrate W while rotating the substrate W.

FIG. 5 is a diagram schematically illustrating a state of processing a substrate in the first high-speed rotation operation of FIG. 3 according to the exemplary embodiment.

Referring to FIG. 5, in the first high-speed rotation operation S12, the first liquid L1 is supplied to the top surface of the substrate W through the first liquid supply nozzle 345. And, the first liquid L1 is supplied to the bottom surface of the substrate W through the back nozzle 362. According to the exemplary embodiment, the first liquid supply nozzle 345 is positioned in an area facing the center area of the top surface of the substrate W, and the first liquid supply nozzle 345 supplies the first liquid L1 to the center area of the top surface of the substrate W. Also, the first liquid L1 is supplied to the center area of the bottom surface of the substrate W from the back nozzle 362.

In the first high-speed rotation operation S12, the rotation speed of the substrate W gradually decreases from a first speed V1 to a second speed V2. The first speed V1 may be a speed at which the first liquid L1 supplied to the center areas of the top and bottom surfaces of the substrate W may spread to the edge area of the substrate W. For example, the first speed V1 may be several hundred rpm. The first speed V1 may be about 200 rpm to 400 rpm.

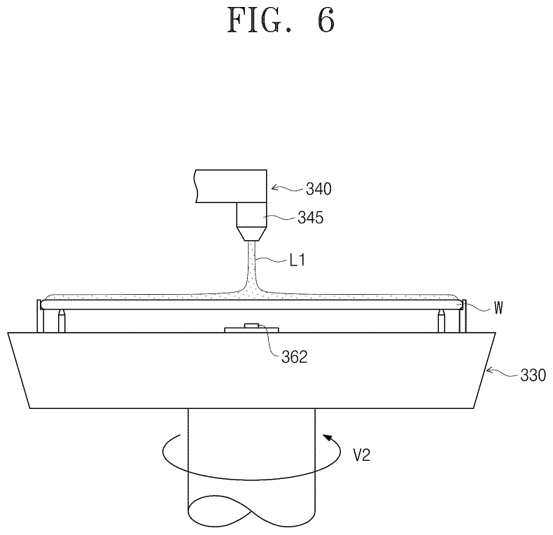

When the rotation speed of the substrate W is reduced to the second speed V2, the first low-speed rotation operation S14 is performed. FIG. 6 is a diagram schematically illustrating a state of processing a substrate in the first low-speed rotation operation of FIG. 3 according to the exemplary embodiment.

Referring to FIG. 6, in the first low-speed rotation operation S14, the supply of the first liquid L1 to the bottom surface of the substrate W is stopped, and the first liquid L1 is supplied only to the top surface of the rotating substrate W. The second speed V2 may be sufficient to form a puddle on the top surface of the substrate W. The second speed V2 is slower than the first speed V1. The second speed V2 may be, for example, 10 rpm or less.

In the first low-speed rotation operation S14, the supply of the first liquid L1 from the back nozzle 462 to the bottom surface of the substrate W is stopped. Referring to FIG. 4, it is illustrated that the supply of the liquid to the bottom surface of the substrate W is stopped at the time t1 at which the rotation speed of the substrate W becomes the second speed V2. The second speed V2 is sufficient to form a puddle on the top surface of the substrate W. Accordingly, when the first liquid L1 is supplied to the bottom surface of the substrate W when the substrate W is rotated at the second speed V2, a problem that the first liquid L1 fails to escape along the bottom surface of the substrate W may occur. As the first liquid L1 remains on the bottom surface of the substrate W, contamination of the substrate W or the back nozzle 462 may occur.

Therefore, when the substrate W rotates at the second speed V2, the supply of the first liquid L1 to the bottom surface of the substrate W is stopped, thereby minimizing the remaining of the first liquid L1 on the bottom surface of the substrate W and preventing contamination of the substrate W or the back nozzle 462.

As the substrate W rotates at the second speed V2 in the first low-speed rotation operation S14, a puddle (liquid accumulation) may be formed on the top surface of the substrate W. When the liquid film of the first liquid L1 is formed on the top surface of the substrate W, the supply of the first liquid to the top surface of the substrate W is stopped. The first liquid supplying operation S10 is terminated, and the liquid film forming operation S20 is performed.

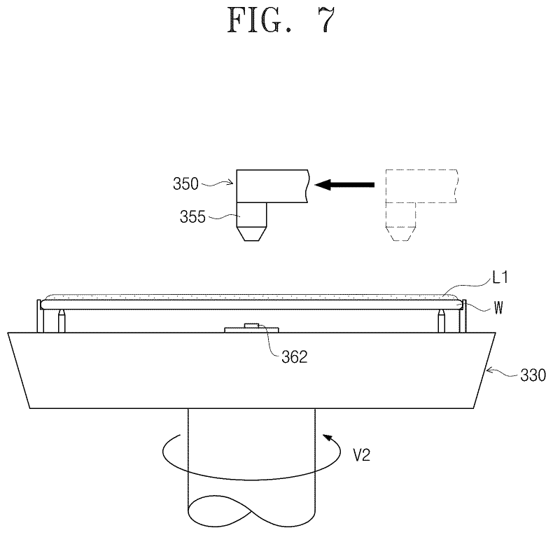

FIG. 7 is a diagram schematically illustrating a state of processing a substrate in the liquid film forming operation of FIG. 3, according to the exemplary embodiment. Referring to FIG. 7, in the liquid film forming operation S20, the substrate W continuously rotates at the second speed V2 to form a liquid film of the first liquid L1 on the top surface of the substrate W. In the liquid film forming operation S20, the first liquid supply nozzle 345 which has stopped supplying the first liquid L1 moves to the standby position, and the second liquid supply nozzle 355 moves from the standby position to the process position in order to supply the second liquid L2 to the top surface of the substrate W. According to the exemplary embodiment, the first liquid supplying operation S10 may be performed for a first time, and the liquid film forming operation S20 may be performed for a second time. The first time may be longer than the second time.

After the second liquid supply nozzle 355 moves to the process position, that is, the position where the center of the second liquid supply nozzle 355 and the center of the substrate W supported by the support unit 330 face each other, the liquid film forming operation S20 is terminated and the second liquid supplying operation S30 is performed.

The second supplying operation S30 is an operation of supplying the second liquid L2 onto the substrate W and replacing the first liquid L1 of the substrate W with the second liquid L2. In the second liquid supplying operation S30, the second liquid L2 is supplied to the substrate W. The second liquid L2 may be an organic solvent. The second liquid L2 may be a liquid containing isopropyl alcohol (IPA).

The second liquid supplying operation S30 includes the second low-speed rotation operation S32 of rotating the substrate W at a few to several tens of rpm while supplying the second liquid L2 to the top surface of the substrate W, and the second high-speed rotation operation S34 of rotating the substrate W at a high speed by incrementally increasing the rotation speed of the substrate W while continuously supplying the second liquid L2 to the top surface of the substrate W.

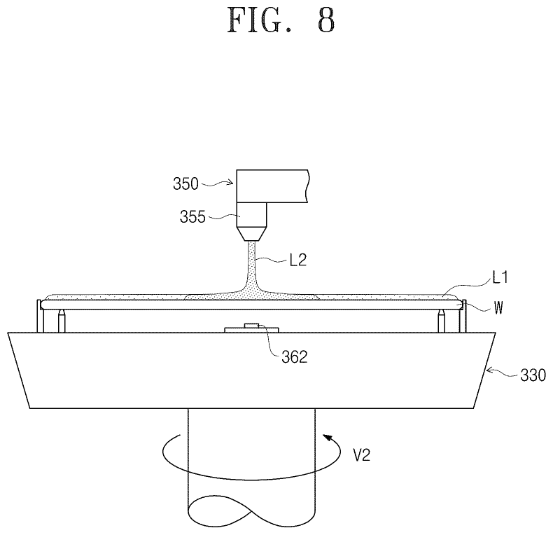

FIG. 8 is a diagram schematically illustrating a state of processing a substrate in the second low-speed rotation operation of FIG. 3 according to the exemplary embodiment. Referring to FIG. 8, in the second low-speed rotation operation S32, the second liquid L2 is supplied to the top surface of the substrate W rotating at the second speed V2 through the second liquid supply nozzle 355. According to an example, the second liquid supply nozzle 355 is positioned in an area facing the center area of the rotating substrate W, and the second liquid supply nozzle 355 supplies the second liquid L2 to the center area of the top surface of the substrate W. The second liquid L2 supplied to the center area of the top surface of the substrate W replaces the liquid film of the first liquid L1 formed on the substrate W with the liquid film of the second liquid L2. Since the second speed V2 is sufficient to form a puddle on the top surface of the substrate W, the liquid film of the first liquid L1 thickly formed on the substrate W is replaced with the second liquid L2 from the center area of the substrate W through which the second liquid L2 is discharged. The second liquid L2 supplied onto the substrate W, which is rotated relatively slowly compared to the second high-speed rotation operation S34 to be described later, may flow only in the area including the center of the substrate W.

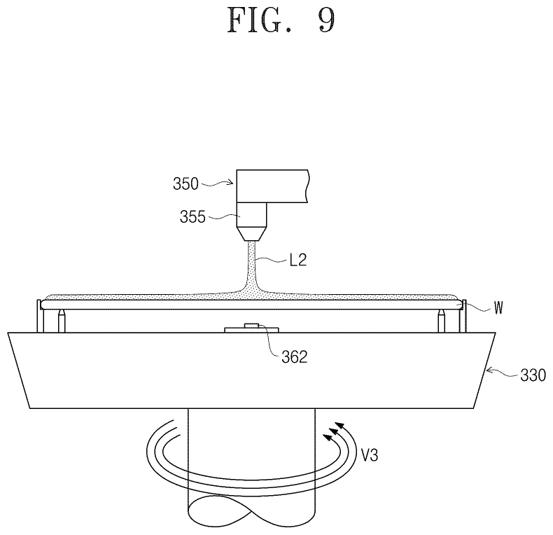

After the liquid film of the first liquid L1 formed in the center area of the substrate W is replaced with the second liquid L2, the second low-speed rotation operation S32 is terminated and the second high-speed rotation operation S34 is performed. FIG. 9 is a diagram schematically illustrating a state of processing a substrate in the second high-speed rotation operation of FIG. 3 according to the exemplary embodiment.

Referring to FIG. 9, in the second high-speed rotation operation S34, the rotation speed of the substrate W is incrementally increased from the second speed V2 to the third speed V3, and while rotating, the second liquid L2 is supplied to the center area of the top surface of the substrate W through the second liquid supply nozzle 355, the liquid film of the first liquid L1 formed on the substrate W is replaced with the second liquid L2. The second high-speed rotation operation S34 may be performed until all of the first liquid L1 previously supplied onto the substrate W is replaced with the second liquid L2. The third speed V3 may be faster than the first speed V1. The third speed V3 may be a speed at which spin-drying of the second liquid L2 replaced on the substrate W is possible. The third speed V3 may be in a range from about 1300 rpm to about 1700 rpm.

After all the first liquid L1 previously supplied onto the substrate W is replaced with the second liquid L2, the second high-speed rotation operation S34 and the second liquid supplying operation S30 are terminated, and the drying operation S40 is performed.

In the drying operation S40, the substrate W is rotated at a high speed to dry the substrate W by using the volatility of the second liquid L2 supplied to the substrate W. The rotation speed of the substrate Win the drying operation S40 may be a third speed V3 or more. While the drying by the IPA solution is performed, the N₂ gas may be injected onto the substrate W by a gas nozzle which is not illustrated. The N₂ gas may function to activate the evaporation of the IPA solution. When the spin-drying of the substrate W is completed, the substrate treatment is terminated.

When the first liquid L1 to the second liquid L2 are sequentially treated on the substrate W, a supply gap of the treatment liquid may occur immediately until the second liquid L2 is supplied after the first liquid L1 is supplied. In addition, as a supply gap of the treatment liquid occurs instantaneously on the substrate W, when the second liquid L2 is supplied to the substrate W, the supplied second liquid L2 may hit the substrate W and rebound, and the rebound liquid may cause particles and contaminate the substrate W. In addition, as a supply gap of the treatment liquid occurs instantaneously on the substrate W, when the second liquid L2 is supplied to the substrate W, the supplied second liquid L2 may hit the substrate W and be rebounded, and the rebounded liquid may cause particles and contaminate the substrate W.

In addition, as a supply gap of the treatment liquid occurs instantaneously on the substrate W, the second liquid L2 is not smoothly applied on the substrate W, and thus a finger ring phenomenon may occur. This may cause a treatment failure of the substrate W.

According to the exemplary embodiment of the present invention described above, the liquid film of the first liquid L1 may be thickened on the substrate W by reducing the rotation speed of the substrate W to the low second speed V2 while supplying the first liquid L1 to the substrate W.

In addition, while the second liquid supply nozzle 355 moves from the standby position to the process position, the liquid film of the first liquid L1 may be formed and maintained on the substrate W by rotating the substrate W at a speed sufficient to form a puddle on the top surface of the substrate W.

As the second liquid L2 is discharged on the thickly formed liquid film of the first liquid L1, it is possible to prevent the second liquid L2 supplied to the substrate W from being rebounded, thereby minimizing contamination of the substrate W. In addition, since the liquid film is continuously formed on the substrate W during a series of processes of supplying the first liquid L1 and the second liquid L2, it is possible to prevent the occurrence of a finger ring phenomenon.

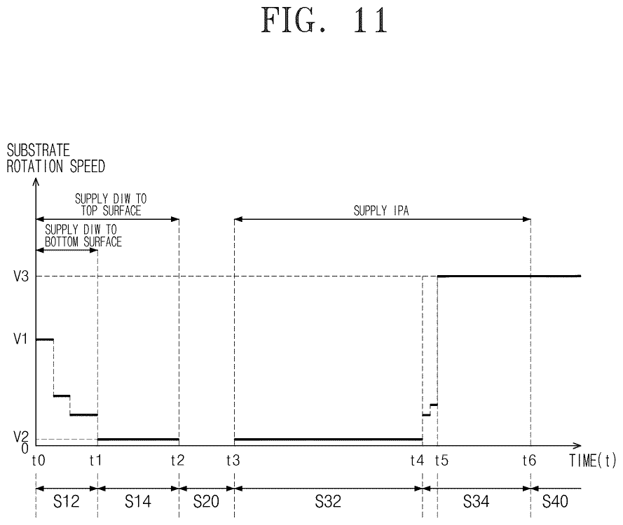

FIGS. 11 to 13 are diagrams illustrating a rotation speed of a substrate and liquid supply according to each operation of FIG. 3 according to other exemplary embodiments.

In the above-described exemplary embodiment, it is illustrated and described that the substrate W rotates at the second speed V2 equal to the rotation speed of the substrate W in the first low speed rotation operation S14. However, unlike this, as illustrated in FIG. 11, the substrate W may stop rotating in the liquid film forming operation S20. Alternatively, in the liquid film forming operation S20, the substrate W may rotate at a speed slower than the second speed V2.

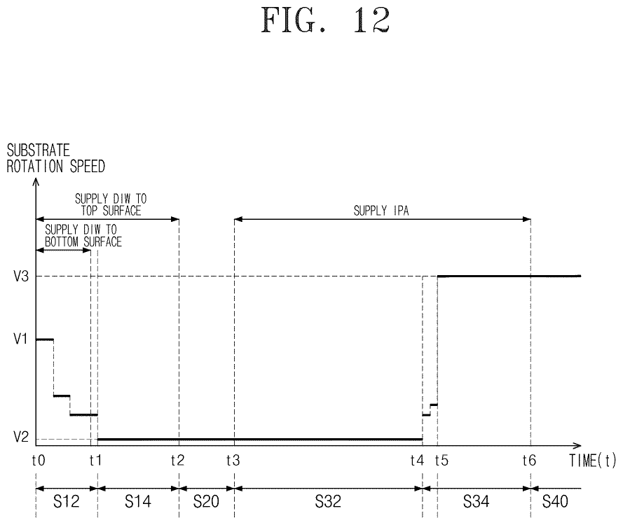

In the above-described exemplary embodiment, it is illustrated and described that the supply of the liquid to the bottom surface of the substrate W is stopped at the time t1 when the rotation speed of the substrate W becomes the second speed V2. However, unlike the above-described exemplary embodiment, the time when the supply of the liquid to the bottom surface of the substrate W is stopped may be a time point before the time t1 when the rotation speed of the substrate W becomes the second speed V2 as illustrated in FIG. 12.

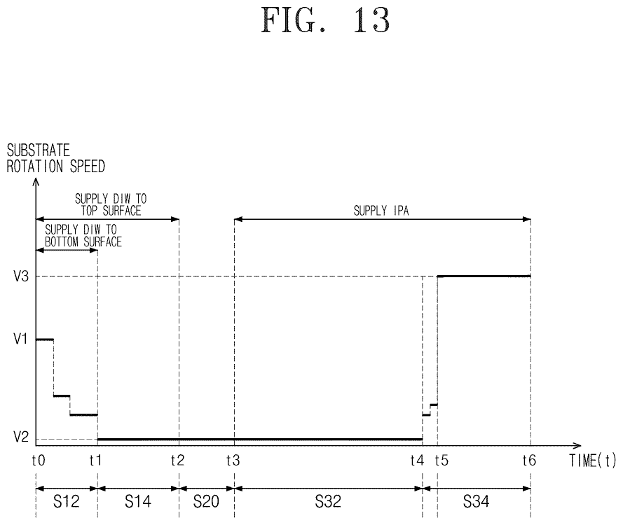

In the above-described exemplary embodiment, it is illustrated and described that the second liquid L2 supplied to the substrate W is dried by rotating the substrate W. However, unlike this, the drying of the substrate W may be performed in a drying chamber which is not illustrated. In the drying chamber, a drying treatment for removing the second liquid L2 remaining on the substrate W by using the supercritical fluid may be performed. For example, supercritical carbon dioxide (scCO₂) may be used as the supercritical fluid. As the drying operation S40 is performed in the drying chamber, the exemplary embodiment of FIG. 4 may be illustrated except for the drying operation S40 as illustrated in FIG. 13.

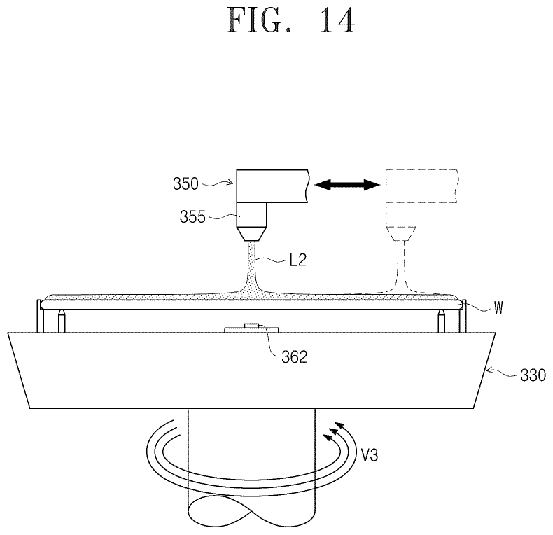

FIG. 14 is a diagram schematically illustrating a state of processing a substrate in the second high-speed rotation operation of FIG. 3 according to another exemplary embodiment. In the above-described exemplary embodiment, it is illustrated and described that the second liquid L2 is supplied to the center of the substrate W through the second liquid supply nozzle 355 in the second high-speed rotation operation S34. However, in the second high-speed rotation operation S34, as illustrated in FIG. 14, the second liquid supply nozzle 355 may supply the second liquid L2 while moving from the center area of the substrate W to the edge area of the substrate W, or may supply the second liquid L2 while reciprocating between the center area of the substrate W and the edge area of the substrate W.

In the above-described exemplary embodiments, it has been illustrated and described that the rotation speed of the substrate W gradually decreases in the first high-speed rotation operation S12 and the rotation speed of the substrate W incrementally increases in the second high-speed rotation operation S34. The gradual decrease and gradual increase in the rotation speed of the substrate illustrated in FIGS. 4, and 11 to 13 are only examples of changes in the rotation speed of the substrate W, whereas the rotation speed of the substrate W may be continuously decreased or increased, and in some cases, the rotation speed of the substrate W may be freely changed, such as an increase and decrease in the rotation speed or a rotation stop.

The specification described above provides examples of the present disclosure. Further, the description provides exemplary embodiments of the present disclosure and the present disclosure may be used in other various combinations, changes, and environments. That is, the present disclosure may be changed or modified within the scope of the present disclosure described herein, within a range equivalent to the description, and/or within the knowledge or technology in the related art. The embodiment shows an optimum state for achieving the spirit of the present disclosure and may be changed in various ways for the detailed application fields and use of the present disclosure. Therefore, the detailed description of the present disclosure is not intended to limit the present disclosure in the embodiment. Further, the claims should be construed as including other embodiments.

1. A method of processing a substrate, the method comprising:
a first liquid supplying operation of supplying a first liquid to a top surface of a substrate,
wherein the first liquid supplying operation includes:
a first high-speed rotation operation of rotating the substrate at a first speed; and
a first low-speed rotation operation of rotating the substrate at a second speed slower than the first speed, and
in the first liquid supplying operation, the first liquid is supplied to a bottom surface of the substrate, and stopping the supply of the first liquid to the bottom surface of the substrate when the substrate is rotating at the second speed.

2. The method of claim 1, wherein in the first high-speed rotation operation, the first liquid is supplied to the substrate while gradually decreasing the rotation speed of the substrate from the first speed to the second speed slower than the first speed.

3. The method of claim 1, further comprising:
after the first liquid supplying operation, a liquid film forming operation of stopping the supply of the first liquid and forming a liquid film of the first liquid on the top surface of the substrate; and
after the liquid film forming operation, a second liquid supplying operation in which the liquid film of the first liquid is replaced with the second liquid by supplying the second liquid to the substrate.

4. The method of claim 3, wherein the first liquid supplying operation is performed for a first time,
the liquid film forming operation is performed for a second time, and
the first time is longer than the second time.

5. The method of claim 3, wherein in the liquid film forming operation, the substrate rotates at the second speed.

6. The method of claim 3, wherein in the liquid film forming operation, the substrate stops rotating.

7. The method of claim 3, wherein the second liquid supplying operation includes a second low-speed rotation operation of supplying the second liquid to a center area of the top surface of the substrate while rotating the substrate at the second speed to replace the liquid film of the first liquid formed in the center area of the top surface of the substrate with the second liquid.

8. The method of claim 7, wherein the second liquid supplying operation includes a second high-speed rotation operation of replacing the liquid film of the first liquid formed on the substrate with the second liquid while incrementally increasing the rotation speed of the substrate from the second speed to a third speed faster than the second speed after the second low-speed rotation operation.

9. The method of claim 8, wherein the third speed is faster than the first speed.

10. The method of claim 8, wherein in the second high-speed rotation operation, the second liquid is supplied to the center area of the substrate.

11. The method of claim 8, wherein in the second high-speed rotation operation, the second liquid is supplied while moving from the center area of the substrate to an edge area of the substrate.

12. The method of claim 3, further comprising:
after the second liquid supplying operation, a drying operation of drying the substrate by volatilizing the second liquid on the substrate.

13. The method of claim 3, wherein the first liquid includes pure water, and
the second liquid contains isopropyl alcohol (IPA).

14. An apparatus for processing a substrate, the apparatus comprising:
a liquid treating chamber for supplying a liquid to a substrate to liquid-treat the substrate; and
a controller for controlling the liquid treating chamber,
wherein the liquid treating chamber includes:
a housing having an inner space;
a support unit for supporting and rotating the substrate within the inner space; and
a liquid supply unit for supplying a liquid to the substrate placed on the support unit, and
the liquid supply unit further includes:
a first liquid supply nozzle for supplying a first liquid to a top surface of the substrate;
a second liquid supply nozzle for supplying a second liquid to the top surface of the substrate; and
a back nozzle for supplying the first liquid to a bottom surface of the substrate, and
the controller supplies the first liquid to the top surface and the bottom surface of the substrate while rotating the substrate at a first speed, supplies the first liquid to the top surface of the substrate while rotating the substrate at a second speed, stops supplying the first liquid, and then rotates the substrate at a second speed so as to form a liquid film of the first liquid on the top surface of the substrate.

15. The apparatus of claim 14, wherein the controller moves the second liquid supply nozzle to the center area of the top surface of the substrate while the supply of the first liquid is stopped and the substrate rotates at the second speed.

16. The apparatus of claim 15, wherein the controller moves the second liquid supply nozzle to the center area of the top surface of the substrate and then controls supply of the second liquid to the center area of the top surface of the substrate through the second liquid supply nozzle while rotating the substrate at the second speed.

17. The apparatus of claim 16, wherein the controller controls the second liquid to be supplied to the substrate through the second liquid supply nozzle while incrementally increasing a rotation speed of the substrate from the second speed to a third speed faster than the second speed.

18. A method of processing a substrate, the method comprising:
a first liquid supplying operation of supplying pure water to a top surface of a substrate;
after the first liquid supplying operation, a liquid film forming operation of stopping the supply of the pure water and forming a liquid film of the pure water on the top surface of the substrate;
after the liquid film forming operation, a second liquid supplying operation in which an organic solvent is supplied to the substrate to replace the pure water of the first liquid with the organic solvent; and
a drying operation of drying the substrate by volatilizing the organic solvent on the substrate,
wherein the first liquid supplying operation includes:
a first high-speed rotation operation of rotating the substrate at a first speed; and
a first low-speed rotation operation of rotating the substrate at a second speed slower than the first speed, and
in the first liquid supplying operation, the pure water is supplied to a bottom surface of the substrate, and when the substrate rotates at the second speed, the supply of the pure water to the bottom surface of the substrate is stopped, and
the second liquid supplying operation further includes:
a second low-speed rotation operation of supplying the organic solvent to a center area of the top surface of the substrate while rotating the substrate at the second speed to replace the liquid film of the pure water formed in the center area of the top surface of the substrate with the organic solvent, and
a second high-speed rotation operation that replaces the liquid film of the pure water formed on the substrate with the organic solvent by supplying the organic solvent to the center area of the substrate while incrementally increasing the rotation speed of the substrate from the second speed to a third speed faster than the second speed, after the second low-speed rotation operation.

19. The method of claim 18, wherein in the liquid film forming operation, the substrate rotates at the second speed.

20. The method of claim 18, wherein the third speed is faster than the first speed.
